(19) United States
(12) Patent Application Publication
(10) Pub. No.: US 2014/0067327 A1
(43) Pub. Date: Mar. 6, 2014

(54) SIMILARITY CURVE-BASED EQUIPMENT FAULT EARLY DETECTION AND OPERATION OPTIMIZATION METHODOLOGY AND SYSTEM

(71) Applicant: China Real-Time Technology Co., Ltd., Beijing (CN)

(72) Inventors: Tao JIANG, Beijing (CN); Yong HUANG, Beijing (CN); Nan BAI, Beijing (CN)

(73) Assignee: China Real-Time Technology Co., Ltd., Beijing (CN)

(21) Appl. No.: 14/070,041

(22) Filed: Nov. 1, 2013

Related U.S. Application Data
(63) Continuation of application No. PCT/CN2012/075037, filed on May 3, 2012.

(30) Foreign Application Priority Data
May 3, 2011 (CN) 201110112631.9

(51) Int. Cl. G06F 11/30

(52) U.S. Cl. CPC G06F 11/30
USPC 702/185

(57) ABSTRACT

A similarity (or health condition evaluation) curve-based equipment fault early detection and operation optimization methodology and system, includes: selection of normal operating data from historical equipment operation records; generation of data collection from normal operating data, and creation of a data model covering equipment multi-operation conditions based on the distribution of data collections; creation of a health condition evaluation or condition similarity curve using continuous relativity calculations between online real-time operating data and historical data in the model; automatic generation of equipment health condition safety baseline through scoring on historical normal equipment operation records; Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

### TECHNOLOGY DOMAIN

This invention belongs to the field of equipment condition monitoring and fault detection, which includes equipment health evaluation, early detection and warning on abnormal operating condition as well as guidance on operation optimization, specifically a similarity (or health condition evaluation) curve-based equipment fault early detection and operation optimization methodology and system.

### TECHNOLOGY BACKGROUND

With the rapid development in modern industry and science and technology, advanced process industry has turned into large scale, complicated structure, strong coupled process units, and with high cost, etc. Meanwhile, the probability of process failure is increasing. Once failed, not only will it lead to enormous casualty and property loss, but also cause huge impact on environment. To enhance safety of processes and control systems, and to improve product quality, reduce product cost, process and equipment health condition monitoring and early warning become necessary.

Real-time data means data stamped with time. Its value changes with time and it accumulated into a large amount with time also. Real-time data exist in all continuous processes, pieces of primary equipment and enterprise remote data centers. Online real-time data mining on data series will provide accurate equipment operating condition information, and provide scientific guidance on equipment safety and efficient operation.

Conventional equipment data monitoring systems are built on top of data sampling systems, which can only provide real-time data display, and analysis on individual variables, as well as post-fault alarming and diagnostics. They cannot provide early and efficient warning analysis on abnormal equipment condition change and fault precursors, therefore cannot provide guidance to equipment safely operation and optimization.

### CONTENTS OF INVENTION

The objective of this invention is to overcome the drawbacks of current technologies, to create data model based on selected normal operating data from equipment historical operating data; through calculating and analyzing the relativity between real-time operating data and normal historical operating data in model, to summarize and create an equipment health condition evaluation curve with a range between 0 to 100%. By automatically setting up a safety baseline value with engineering meaning to realize the early warning on abnormal equipment operating condition change, and guidance to operation optimization is provided based on the order of process variables in terms of relative change rate and expected normal operating values.

This invention provides a similarity (or health condition evaluation) curve-based equipment fault early detection, early warning and operation optimization methodology:

Selection: selecting normal operating data from historical equipment operation records;

Model Creation: with the normal historical operation data selected from Selection step, generating a collection of normal operating data covering all available operating conditions, and selecting data from the data collection based on data distribution, creating a data model to reflect normal equipment operation. The said collection of data includes multiple operating variables of equipment;

Generation: calculating health condition evaluation values and furthermore, creating a health condition evaluation curve using continuous relativity calculations between online real-time operating data and historical data in the model, with the consideration of correlation relationship and operation law between all operating variables;

Definition: automatic generation of equipment health condition safety baseline through scoring on historical normal equipment operation records using generated model;

Early Warning and Optimization: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

In an implemented project, at Selection step, normal historical equipment operating data should satisfy the following requirements: covering a period of operation under all available conditions, all selected operating data values for all process variables are within normal operating ranges and represent equipment normal operations, also a data snapshot of all process variables must be collected at the same time stamp.

In an implemented project, at Model Creation step, from a collection of normal operating data to select typical characterized data for model creation, the said typical characterized data collection includes the minimum and maximum operating states; selecting data covering multi operating conditions from the data collection based on data distribution, i.e., selecting less typical characterized data snapshots in the dense distributed space while selecting more in sparse distributed space.

In an implemented project, at Generation step, online sampling data from every process variable to form a said online real-time data collection, calculating health condition evaluation values and furthermore, creating a health condition evaluation curve using continuous relativity calculations between online real-time operating data and historical data in the model, with the consideration of the correlation relationship and operation law between all operating variables;

In an implemented project, at Generation step, the said continuous relativity calculations including data normalization, relativity calculation and equipment health calculation;

The said normalization is to normalize all the process variable measurements;

The said relativity calculation is to calculate the relationship between all data collection in model and the real-time data snapshot by the following formula:

$${r}_{i} ( V ) = \frac{{c}_{1} \cdot ‖ V - {Vm}_{i} ‖}{\sqrt{{\sum }_{j = 1}^{m} {‖ V - {Vm}_{j} ‖}^{2}}}$$

where
c₁ is a constant;
V presents a real-time data snapshot;
Vmᵢ presents a data vector in model data collection;
m is total number of data vectors in model;
rᵢ(V) is the relativity between V and Vmᵢ, which has a value between 0 to 100%;

In an implemented project, at Definition step, health indicator values h(Vₙ) are calculated by the relativity values given in claim 5. And the safety baseline value b is calculated by equipment health indicator values h(Vₙ):

$$h ( {V}_{k} ) = \frac{{c}_{2}}{m} \sqrt{{\sum }_{i = 1}^{m} {( {r}_{i} ( {V}_{k} ) )}^{2}}$$

$$b = {c}_{3} \cdot \frac{{{Max}_{k = 1}}^{n} h ( {V}_{k} ) - {{Min}^{n} h ( {V}_{k} )}_{k = 1}}{\sqrt{{\sum }_{k = 1}^{n} {( h ( {V}_{k} ) )}^{2}}} ,$$

where n is the number of data vectors in model, c₃ is a constant, b is between 0 and 100%

In an implemented project, at Early Warning and Optimization step, when health condition evaluation value decreases below the safety baseline value, early warning on equipment operating condition abnormal change is published

In an implemented project, at Early Warning and Optimization step, guidance on operation optimization is provided and includes the expected normal values of each abnormally changed process variable, and furthermore, the weighting on relativity is calculated as:

$${w}_{i} = {c}_{4} \cdot \frac{{r}_{i} ( V )}{\sqrt{{\sum }_{i = 1}^{m} {( {r}_{i} ( V ) )}^{2}}} ,$$

where c₄ is a constant, the value of wᵢ is between 0 and 100%
The expected values of process variables can be calculated by:

$${V}_{e} = {c}_{S} \cdot {\sum }_{i = 1}^{m} ( {w}_{i} \cdot {Vm}_{i} ) ,$$

where c₅ is a constant

The expected normal value of each abnormally changed process variable can be obtained from Vₑ.

In an implemented project, at Early Warning and Optimization step, when real-time health condition evaluation value decreases below the safety baseline value, with the obtaining of expected normal values of each abnormally changed process variable, a relative 120 change rate of ΔV(i) of each process variable is calculated and the variables are ordered based on the values of the change rate from high to low, variable with the highest change rate will be referenced as the key starting point for abnormality investigation. The relative change rate ΔV(i) is calculated as:

$$Δ V ( i ) = \frac{\vert V ( i ) - {V}_{e} ( i ) \vert}{{V}_{e} ( i )} ,$$

where i refers to the ith variable
Guidance to equipment operation optimization is provided based on the order of process variables in terms of relative change rate and expected normal operating values.

This invention also provides a similarity (or health condition evaluation) curve-based equipment fault early detection, early warning and operation optimization system:

Selection: selecting normal operating data from historical equipment operation records;

Model Creation: with the normal historical operation data selected from Selection step, generating a collection of normal operating data covering all available operating conditions, and selecting data from the data collection based on data distribution, creating a data model to reflect normal equipment operation. The said collection of data includes multiple operating variables of equipment;

Generation: calculating health condition evaluation values and furthermore, creating a health condition evaluation curve using continuous relativity calculations between online real-time operating data and historical data in the model, with the consideration of correlation relationship and operation law between all operating variables;

Definition: automatic generation of equipment health condition safety baseline through scoring on historical normal equipment operation records using generated model;

Early Warning and Optimization: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

This invention also provides a readable computer medium includes commands. The said commands are executed, when the process system starts running, to operate the similarity (or health condition evaluation) curve-based equipment fault early detection and operation optimization process.

### INSTRUCTION

### Appended Figures

FIG. 1. Flow Chart of Methodology in First Implemented Project

FIG. 2. Flow Chart on Model Creation

FIG. 3. Flow Chart on Generation of Equipment Health Condition Evaluation Curve

FIG. 4. Flow Chart on Rule Definition of Early Warning on Abnormal Health Condition Change

FIG. 5. Illustration on provided Early Warning based on health condition evaluation curve and Optimization Guidance

FIG. 6. Illustration on provided similarity (or health condition evaluation) curve-based equipment condition early warning and optimization system

### DETAILED IMPLEMENTATION

This paragraph will illustrate the first implementation with figures.

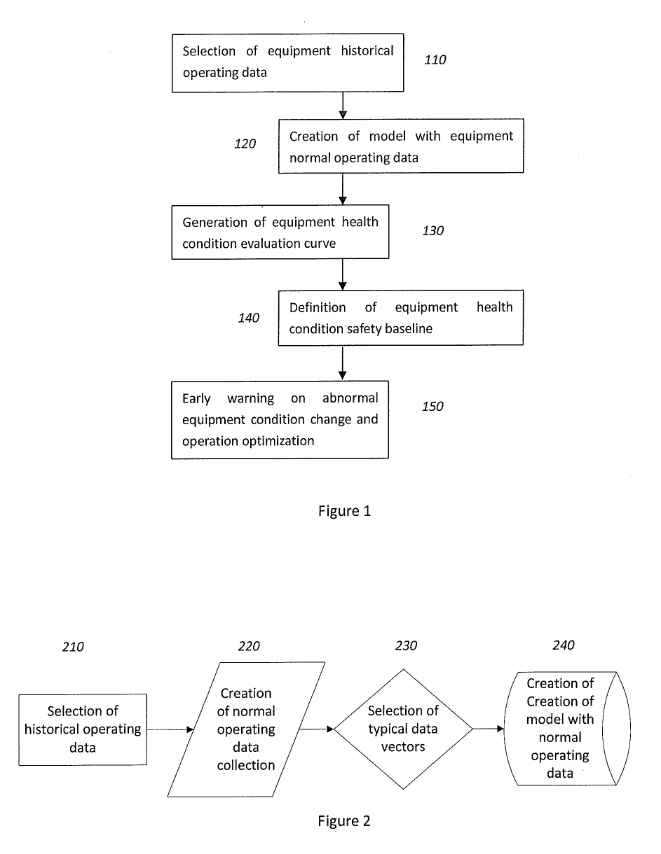

FIG. 1 illustrates the flow of methodology

Step 110: selecting normal operating data from historical equipment operation records. During a period of time, all process variable readings are within normal operating ranges by removing abnormal readings as well perturbations.

Step 120: with the normal historical operation data selected from Selection step (110), generating a collection of normal operating data covering all available operating conditions, and selecting data from the data collection based on data distribution, creating a data model to reflect normal equipment operation. The said collection of data includes multiple operating variables of equipment;

Step 130: calculating health condition evaluation values and furthermore, creating a health condition evaluation curve using continuous relativity calculations between online real-time operating data and historical data in the model, with the consideration of correlation relationship and operation law between all operating variables;

Step 140: automatic generation of equipment health condition safety baseline through scoring on historical normal equipment operation records using generated model;

Step 150: Based on the change of equipment health condition evaluation curve against the safety baseline, early warning on equipment health condition abnormal change is published, Guidance to equipment operation optimization is provided based on the order of process variables in terms of relative change rate and expected normal operating values.

Data model is built with the selected normal historical equipment operating data which should satisfy the following requirements:

covering a period of operation under all available conditions;

all selected operating data values for all process variables are within normal operating ranges and represent equipment normal operations;

also a data snapshot of all process variables must be collected at the same time stamp.

For example, a large compressor has 24 process variables including temperature, pressure, flow rate and vibration, etc. At a sampling rate of once per minute and collect 190 online operating data for 168 hours, totally 10080 samples will be obtained which composes the data collection for normal data model built.

FIG. 2 illustrates the model built process

Every sampled data snapshot described above represents a normal operating state of the compressor, covering different operating conditions of compressor. By analyzing the 10080 sampled data, selects the representative data vectors, e.g., 360 representative samples, to form the model. The selection of the typical representative data vectors follows this rule:

Should include the maximum and minimum states of the data collection. For example, with 24 process variables, there are maximum 48 data vectors having minimum and maximum values of each variable in the representative data collections; selecting multi operating condition data from the data collection based on data distribution to form the model with normal operating states, to ensure data in the model would fully cover all normal operating conditions.

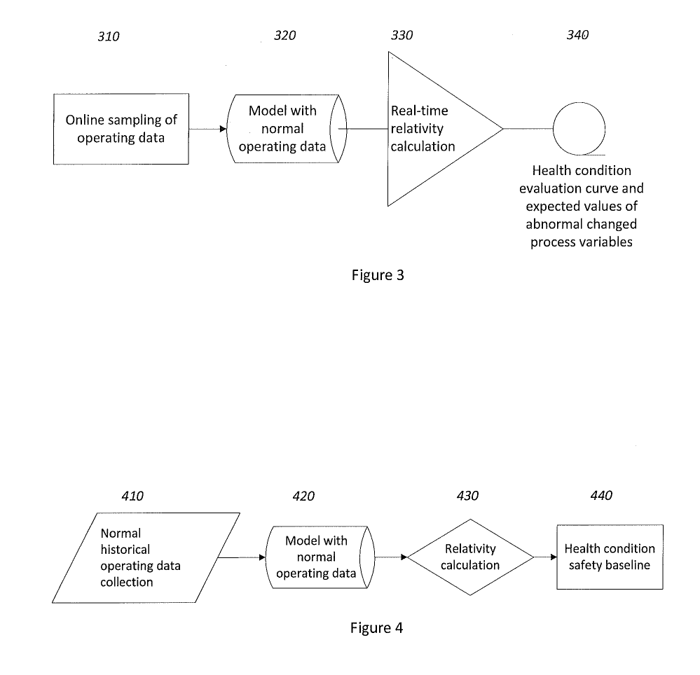

FIG. 3 illustrates the generation of health condition evaluation curve

Online sampling data from every process variable forms a said online real-time data collection, which is used for relativity calculation with every state vector in model. The said relativity calculation is following such steps:

Normalization: The said normalization is to normalize all the process variable measurements;

Through normalization, the relativity and health indicator values obtained from the Generation step are converted to unit-less values of 0-100%. The said relativity calculation is to calculate the relationship between all data collection in model and the real-time data snapshot by the following formula:

$${r}_{i} ( V ) = \frac{{c}_{1} \cdot ‖ V - {Vm}_{i} ‖}{\sqrt{{\sum }_{j = 1}^{m} {‖ V - {Vm}_{j} ‖}^{2}}}$$

where
c₁ is a constant;
V presents a real-time data snapshot;
Vmᵢ presents a data vector in model data collection;
m is total number of data vectors in model;
rᵢ(V) is the relativity between V and Vmᵢ, which has a value between 0 to 100%;

The said health indicator h(V) is calculated from the relativity values between real-time operating data and normal historical operating data in the model:

$$h ( V ) = \frac{{c}_{2}}{m} \sqrt{{\sum }_{i = 1}^{n} {( {r}_{i} ( V ) )}^{2}}$$

Where c₂ is the constant coefficient

Health indicator h(V) is a value between 0 to 100%. The higher the value, the healthier the equipment

Health condition evaluation values are calculated between real-time operating data and every historical data snapshot in the model. Furthermore, a health condition evaluation curve is created using continuous relativity calculations. FIG. 4 illustrates the rule definition process of early warning on abnormal health condition change.

Early warning on abnormal health condition change is provided through defining the equipment health condition safety baseline. By analyzing the historical operating data, the safety baseline value of b is automatically generated. When health indicator value h(Vₙ) is below the value of b, in combining with identifying abnormally-changed process variables which lead to the decrease of health condition evaluation values, early warning on equipment health condition change is published.

The safety baseline value of b is automatically generated by analyzing the historical operating data. In the compressor example, there are 10080 normal operating samples and 10080 relativity values will be generated through model calculations, which cover all historical normal operating conditions. Then the equipment safety baseline value b on health condition evaluation can be calculated by:

$$h ( {V}_{k} ) = \frac{{c}_{2}}{m} \sqrt{{\sum }_{i = 1}^{m} {( {r}_{i} ( {V}_{k} ) )}^{2}}$$

$$b = {c}_{3} \cdot \frac{{{Max}_{k = 1}}^{n} h ( {V}_{k} ) - {{Min}_{k = 1}}^{n} h ( {V}_{k} )}{\sqrt{{\sum }_{k = 1}^{n} {( h ( {V}_{k} ) )}^{2}}} ,$$

where n is the number of data vectors in model, c₃ is a constant, b is between 0 and 100%

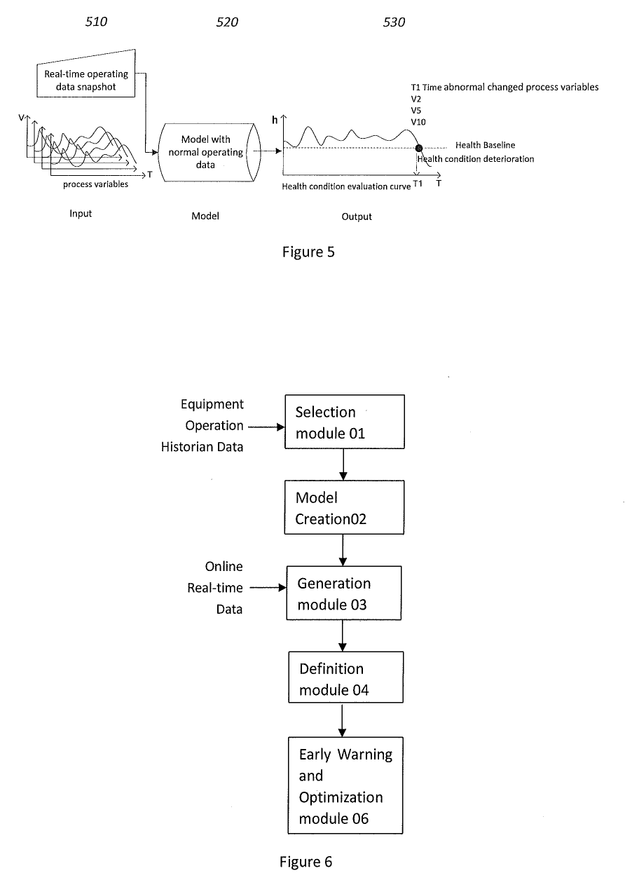

FIG. 5 illustrates the process of early warning publish based on health condition evaluation curve and optimization guidance provided.

The real-time online sampled data during equipment operation as inputs to model generate a series of health indicator values h(Vₙ) to create the health condition evaluation curve. When equipment starts to operate abnormally, the health condition evaluation curve will show corresponding decrease trend before fault appear. When health condition value bellows the safety baseline value of b, i.e., the current equipment operating state is beyond the historical normal operating states, in combining with identifying abnormally-changed process variables which lead to the decrease of health condition evaluation values, early warning on equipment health condition change is published. Plus, optimization is performed to avoid or eliminate potential equipment failure based on the order of process variables and expected normal operating values; i.e., based on the order of process variables in terms of relative change rate, optimally controlling/adjusting relevant process variables to prevent further potential failure deterioration, so to achieve a long-term stable and optimal operation.

The expected values of process variables are calculated from the weighting on relativity, and furthermore, the weighting on relativity is calculated as:

$${w}_{i} = {c}_{4} \cdot \frac{{r}_{i} ( V )}{\sqrt{{\sum }_{i = 1}^{m} {( {r}_{i} ( V ) )}^{2 }}} ,$$

where c₄ is a constant, the weighting of wᵢ is between 0 and 100%
The expected values of process variables can be calculated by:

$${V}_{e} = {c}_{5} \cdot {\sum }_{i = 1}^{m} ( {w}_{i} \cdot {Vm}_{i} ) ,$$

where c₅ is a constant

Expected normal values of abnormally changed process variables can be obtained from the collection of expected values Vₑ. The variables will be reordered from maximum to minimum values on relative change rate of ΔV(i). Variable with the highest change rate will be referenced as the key starting point for abnormality investigation. The relative change rate ΔV(i) is calculated as:

$$Δ V ( i ) = \frac{\vert V ( i ) - {V}_{e} ( i ) \vert}{{V}_{e} ( i )} ,$$

where i refers to the ith variable

Guidance to equipment operation optimization is provided based on the order of process variables in terms of relative change rate and expected normal operating values.

In the example of the compressor, it the compressor at T1 in FIG. 5 was registered an early warning on failure, according to the normal expected values as well as the order of the process variables, 3 variables are leading to the health h(Vₙ) change: continuous decrease of lubrication oil pressure (V2), continuous increase of vibration (V5) and continuous increase of lube temperature (V10), even though all 3 of them are still within normal operating thresholds, and the other 21 variables are normal. This tells that the lube oil seal system needs to be checked and repaired to prevent potential oil leak problem which could lead to compressor failure.

This first implementation in this invention applies a similarity (or health condition evaluation) curve-based equipment fault early detection and operation optimization system. FIG. 6 illustrates the modules of this system:

Selection module 01: with historical equipment operating data as inputs, provides normal historical operating data;

Model Creation module 02: with normal historical operating data from Selection module as inputs, generates a collection of normal operating data covering all available operating conditions, and selects data from the data collection based on data distribution, creating a data model to reflect normal equipment operation. The said collection of data includes multiple operating variables of equipment;

Generation module 03: with online real-time operating data snapshots as model input, calculates health condition evaluation values and furthermore, creates a health condition evaluation curve using continuous relativity calculations between online real-time operating data and historical data in the model, with the consideration of correlation relationship and operation law between all operating variables;

Definition module 04: with normal historical operating data records as model, automatically generates equipment health condition safety baseline through scoring on historical normal equipment operation records using generated model;

Early Warning and Optimization module 05: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

1. A similarity curve-based equipment fault early detection and operation optimization methodology and system, which is characterized in following steps:
Selection: selecting normal operating data from historical equipment operation records;
Model Creation: with the normal historical operation data selected from Selection step, generating a collection of normal operating data covering all available operating conditions, and selecting data from the data collection based on data distribution, creating a data model to reflect normal equipment operation. The said collection of data includes multiple operating variables of equipment;
Generation: calculating health condition evaluation values and furthermore, creating a health condition evaluation curve using continuous relativity calculations between online real-time operating data and historical data in the model, with the consideration of correlation relationship and operation law between all operating variables;
Definition: automatic generation of equipment health condition safety baseline through scoring on historical normal equipment operation records using generated model;
Early Warning and Optimization: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

2. The similarity curve-based equipment fault early detection and operation optimization methodology and system according to claim 1, at Selection step, normal historical equipment operating data should satisfy the following requirements: covering a period of operation under all available conditions, all selected operating data values for all process variables are within normal operating ranges and represent equipment normal operations, also a data snapshot of all process variables must be collected at the same time stamp.

3. The similarity curve-based equipment fault early detection and operation optimization methodology and system according to claim 1, at Model Creation step, from a collection of normal operating data to select typical characterized data for model creation, the said typical characterized data collection includes the minimum and maximum operating states; selecting data covering multi operating conditions from the data collection based on data distribution, i.e., selecting less typical characterized data snapshots in the dense distributed space while selecting more in sparse distributed space.

4. The similarity curve-based equipment fault early detection and operation optimization methodology and system according to claim 1, at Generation step, online sampling data from every process variable to form a said online real-time data collection, calculating health condition evaluation values and furthermore, creating a health condition evaluation curve using continuous relativity calculations between online real-time operating data and historical data in the model, with the consideration of the correlation relationship and operation law between all operating variables;

5. The similarity curve-based equipment fault early detection and operation optimization methodology and system according to claim 4, at Generation step, the said continuous relativity calculations including data normalization, relativity calculation and equipment health calculation;
The said normalization is to normalize all the process variable measurements;
The said relativity calculation is to calculate the relationship between all data collection in model and the real-time data snapshot by the following formula:
$${r}_{i} ( V ) = \frac{{c}_{1} \cdot ‖ V - {Vm}_{i} ‖}{\sqrt{{\sum }_{j = 1}^{m} {‖ V - {Vm}_{j} ‖}^{2}}}$$
where
c₁ is a constant;
V presents a real-time data snapshot;
Vmᵢ presents a data vector in model data collection;
m is total number of data vectors in model;
rᵢ(V) is the relativity between V and Vmᵢ, which has a value between 0 to 100%;
The said health indicator h(V) is calculated from the relativity values between real-time operating data and normal historical operating data in the model:
$$h ( V ) = \frac{{c}_{2}}{m} \sqrt{{\sum }_{i = 1}^{m} {( {r}_{i} ( V ) )}^{2}}$$
Where c₂ is the constant coefficient
Health indicator h(V) is a value between 0 to 100%. The higher the value, the healthier the equipment.

6. The similarity curve-based equipment fault early detection and operation optimization methodology and system according to claim 4, at Definition step, health indicator values h(Vₙ) are calculated by the following process:
based on claim 4, at Generation step, the continuous relativity calculations including data normalization, relativity calculation and equipment health calculation;
the said normalization is to normalize all the process variable measurements;
the said relativity calculation is to calculate the relationship between all data collection in model and the real-time data snapshot by the following formula:
$${r}_{i} ( V ) = \frac{{c}_{1} \cdot ‖ V - {Vm}_{i} ‖}{\sqrt{{\sum }_{j = 1}^{m} {‖ V - {Vm}_{j} ‖}^{2}}}$$
where
c₁ is a constant;
V presents a real-time data snapshot;
Vmᵢ presents a data vector in model data collection;
m is total number of data vectors in model;
rᵢ(V) is the relativity between V and Vmᵢ, which has a value between 0 to 100%
the said health indicator h(V) is calculated from the relativity values between real-time operating data and normal historical operating data in the model:
$$h ( V ) = \frac{{c}_{2}}{m} \sqrt{{\sum }_{i = 1}^{m} {( {r}_{i} ( V ) )}^{2}}$$
where c₂ is the constant coefficient health indicator h(V) is a value between 0 to 100%, the higher the value, the healthier the equipment;
the safety baseline value b is calculated by equipment health indicator values h(Vₙ):
$$h ( {V}_{k} ) = \frac{{c}_{2}}{m} \sqrt{{\sum }_{i = 1}^{m} {( {r}_{i} ( {V}_{k} ) )}^{2}}$$
$$b = {c}_{3} \cdot \frac{{{Max }_{k = 1}}^{n} h ( {V}_{k} ) - {{Min}_{k = 1}}^{n} h ( {V}_{k} )}{\sqrt{{\sum }_{k = 1}^{n} {( h ( {V}_{k} ) )}^{2}}} ,$$
where n is the number of data vectors in model, c₃ is a constant, b is between 0 and 100%.

7. The similarity curve-based equipment fault early detection and operation optimization methodology and system according to claim 1, at Early Warning and Optimization step, when health condition evaluation value decreases below the safety baseline value, early warning on equipment operating condition abnormal change is published.

8. The similarity curve-based equipment fault early detection and operation optimization methodology and system according to claim 1, at Early Warning and Optimization step, guidance on operation optimization is provided and includes the expected normal values of each abnormally changed process variable, and furthermore, the weighting on relativity is calculated as:
$${w}_{i} = {c}_{4} \cdot \frac{{r}_{i} ( V )}{\sqrt{{\sum }_{i = 1}^{m} {( {r}_{i} ( V ) )}^{2}}} ,$$
where c₄ is a constant, the value of wᵢ is between 0 and 100%
The expected values of process variables can be calculated by:
$${V}_{e} = {c}_{5} \cdot {\sum }_{i = 1}^{m} ( {w}_{i} \cdot {Vm}_{i} ) ,$$
where c₅ is a constant
The expected normal value of each abnormally changed process variable can be obtained from Vₑ

9. The similarity curve-based equipment fault early detection and operation optimization methodology and system according to claim 7, at Early Warning and Optimization step, when real-time health condition evaluation value decreases below the safety baseline value, with the obtaining of expected normal values of each abnormally changed process variable, a relative change rate of ΔV(i) of each process variable is calculated and the variables are ordered based on the values of the change rate from high to low, variable with the highest change rate will be referenced as the key starting point for abnormality investigation. The relative change rate ΔV(i) is calculated as:
$$Δ V ( i ) = \frac{\vert V ( i ) - {V}_{e} ( i ) \vert}{{V}_{e} ( i )} ,$$
where i refers to the ith variable
Guidance to equipment operation optimization is provided based on the order of process variables in terms of relative change rate and expected normal operating values.

10. A similarity curve-based equipment fault early detection and operation optimization system, includes:
Selection module: with historical equipment operating data as inputs, provides normal historical operating data;
Model Creation module: with normal historical operating data from Selection module as inputs, generates a collection of normal operating data covering all available operating conditions, and selects data from the data collection based on data distribution, creating a data model to reflect normal equipment operation. The said collection of data includes multiple operating variables of equipment;
Generation module: with online real-time operating data snapshots as model input, calculates health condition evaluation values and furthermore, creates a health condition evaluation curve using continuous relativity calculations between online real-time operating data and historical data in the model, with the consideration of correlation relationship and operation law between all operating variables;
Definition module: with normal historical operating data records as model, automatically generates equipment health condition safety baseline through scoring on historical normal equipment operation records using generated model;
Early Warning and Optimization module: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.

11. A readable computer medium includes commands. The said commands are executed, when the process system starts running, to operate the similarity (or health condition evaluation) curve-based equipment fault early detection and operation optimization system, includes:
Selection: selecting normal operating data from historical equipment operation records;
Model Creation: with the normal historical operation data selected from Selection step, generating a collection of normal operating data covering all available operating conditions, and selecting data from the data collection based on data distribution, creating a data model to reflect normal equipment operation. The said collection of data includes multiple operating variables of equipment;
Generation: calculating health condition evaluation values and furthermore, creating a health condition evaluation curve using continuous relativity calculations between online real-time operating data and historical data in the model, with the consideration of correlation relationship and operation law between all operating variables;
Definition: automatic generation of equipment health condition safety baseline through scoring on historical normal equipment operation records using generated model;
Early Warning and Optimization: Based on the change of equipment health condition evaluation curve against the safety baseline, in combining with identifying abnormally-changed process variables which lead to the decrease of health condition evaluation values, early warning on equipment health condition change is published and guidance on equipment operation optimization is provided.
